(19) United States
(12) Patent Application Publication
(10) Pub. No.: US 2026/0072257 A1
(43) Pub. Date: Mar. 12, 2026

(54) OPTICAL SYSTEM AND IMAGE PICKUP APPARATUS

(71) Applicant: CANON KABUSHIKI KAISHA, Tokyo (JP)

(72) Inventor: Kento TSUCHIYA, Tokyo (JP)

(21) Appl. No.: 19/303,686

(22) Filed: Aug. 19, 2025

(30) Foreign Application Priority Data
Sep. 12, 2024 (JP) 2024-158008

(51) Int. Cl. G02B 15/14; G02B 13/00; H04N 23/55

(52) U.S. Cl. CPC G02B 15/143105; G02B 13/0035; H04N 23/55

(57) ABSTRACT

Optical systems and image pickup apparatuses are provided herein. One or more optical systems may include, in order from an object side to an image side, a first lens unit with positive refractive power, and a second lens unit with negative refractive power. The optical system may be a fixed focal length lens. Each distance between adjacent lens units changes during focusing. During focusing, the first lens unit does not move and the second lens unit may move. Predetermined inequalities may be satisfied.

### BACKGROUND

### Field of the Technology

The disclosure relates to one or more embodiments of an optical system for imaging.

### Description of the Related Art

An optical system for imaging disclosed in Japanese Patent Application Laid-Open No. 2023-168803 includes, in order from the object side, a first lens unit with positive refractive power that does not move during focusing, a second lens unit with negative refractive power that moves during focusing, and a third lens unit with positive refractive power that does not move during focusing.

### SUMMARY

One or more embodiments of an optical system according to one or more aspects of the disclosure may include, in order from an object side to an image side, a first lens unit with positive refractive power, and a second lens unit with negative refractive power. The optical system is a fixed focal length lens. Each distance between adjacent lens units changes during focusing. During focusing, the first lens unit does not move and the second lens unit moves. The following inequality is satisfied:

$$- 8.50 \leq f 2 / f \leq - 1 \text{.15}$$

$$10. \leq vdgn 1 \leq 31.$$

$$0.8 \leq SG \leq 2.38$$

where f is a focal length of the optical system, f2 is a focal length of the second lens unit, νdgn1 is an Abbe number based on d-line of a negative lens closest to an object among at least one negative lens included in the first lens unit, and SG is a minimum value of specific gravities of all lenses included in the second lens unit. One or more image pickup apparatuses may include one or more optical systems in accordance with one or more other aspects of the disclosure.

Features of the present disclosure will become apparent from the following description of embodiments with reference to the attached drawings. The following description of embodiments is described by way of example.

### BRIEF DESCRIPTION OF THE DRAWINGS

FIG. 1 is a sectional view of an optical system according to Example 1.

FIG. 2 is an aberration diagram for the optical system according to Example 1 in an in-focus state at infinity.

FIG. 3 is an aberration diagram for the optical system according to Example 1 in an in-focus state at the closest distance.

FIG. 4 is a sectional view of an optical system according to Example 2.

FIG. 5 is an aberration diagram for the optical system according to Example 2 in an in-focus state at infinity.

FIG. 6 is an aberration diagram for the optical system according to Example 2 in an in-focus state at the closest distance.

FIG. 7 is a sectional view of an optical system according to Example 3.

FIG. 8 is an aberration diagram for the optical system according to Example 3 in an in-focus state at infinity.

FIG. 9 is an aberration diagram for the optical system according to Example 3 in an in-focus state at the closest distance.

FIG. 10 is a sectional view of an optical system according to Example 4.

FIG. 11 is an aberration diagram for the optical system according to Example 4 in an in-focus state at infinity.

FIG. 12 is an aberration diagram for the optical system according to Example 4 in an in-focus state at the closest distance.

FIG. 13 is a sectional view of an optical system according to Example 5.

FIG. 14 is an aberration diagram for the optical system according to Example 5 in an in-focus state at infinity.

FIG. 15 is an aberration diagram for the optical system according to Example 5 in an in-focus state at the closest distance.

FIG. 16 is a sectional view of an optical system according to Example 6.

FIG. 17 is an aberration diagram for the optical system according to Example 6 in an in-focus state at infinity.

FIG. 18 is an aberration diagram for the optical system according to Example 6 in an in-focus state at the closest distance.

FIG. 19 is a sectional view of an optical system according to Example 7.

FIG. 20 is an aberration diagram for the optical system according to Example 7 in an in-focus state at infinity.

FIG. 21 is an aberration diagram for the optical system according to Example 7 in an in-focus state at the closest distance.

FIG. 22 is a sectional view of an optical system according to Example 8.

FIG. 23 is an aberration diagram of the optical system according to Example 8 in an in-focus state at infinity.

FIG. 24 is an aberration diagram of the optical system according to Example 8 in an in-focus state at the closest distance.

FIG. 25 illustrates an image pickup apparatus having the optical system according to any one of Examples 1 to 8.

### DESCRIPTION OF THE EMBODIMENTS

Referring now to the accompanying drawings, a description will be given of examples according to the disclosure. Before specific Examples 1 to 8 are descried, matters common to each example will be discussed.

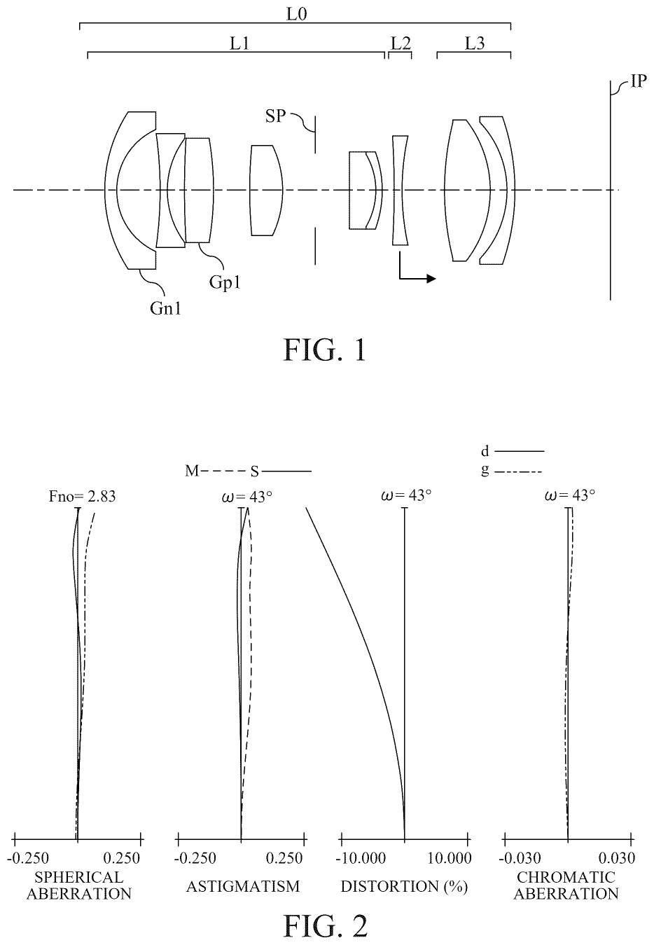

FIGS. 1, 4, 7, 10, 13, 16, 19, and 22 illustrate cross sections of optical systems L0 according to Examples 1 to 8 in an in-focus state on an object at infinity (referred to as “in an in-focus state at infinity” hereinafter). The optical system L0 is a fixed focal length lens. The optical system L0 according to each example is used for various image pickup apparatuses such as digital video cameras, digital still cameras, film-based cameras, broadcasting cameras, and surveillance cameras.

In each figure, a left side is an object side (front side), and a right side is an image side (rear side). The optical system L0 according to each example includes a plurality of lens units. A lens unit is a group of one or more lenses that move or do not move (are fixed) as a whole during focusing. That is, in the optical system L0 according to each example, each distance between adjacent lens units changes during focusing. The lens units may include an aperture stop (diaphragm).

In each figure, Li represents an i-th (i=1, 2, 3) lens unit counted from the object side. In each figure, an arrow below a lens unit (focus unit) that moves during focusing indicates a moving direction of the focus unit during focusing from infinity to the closest distance.

SP is an aperture stop. IP is an image plane. An imaging surface (light receiving surface) of an image sensor such as a CCD sensor or CMOS sensor, or a film surface (photosensitive surface) of a silver film is disposed on the image plane IP.

The optical system L0 according to each example includes, in order from the object side to the image side, a first lens unit L1 with positive refractive power, and a second lens unit L2 with negative refractive power. The positive refractive power of the first lens unit L1 and the negative refractive power of the second lens unit L2 can reduce the diameter of the light beam incident on the second lens unit L2, and reduce the size and weight of the focus unit.

In the optical system L0 according to each example, the second lens unit L2 moves as a focus unit during focusing. Thereby, fluctuations in the angle of view that occur during focusing can be suppressed.

The optical system L0 according to each example may satisfy at least one of the following inequalities (1) to (3):

$$- 8.50 \leq f 2 / f \leq - 1 \text{.15} \qquad ( 1 )$$

$$10. \leq vdgn 1 \leq 31. \qquad ( 2 )$$

$$0.8 \leq SG \leq 2.38 \qquad ( 3 )$$

In these inequalities, f is a focal length of the optical system L0, and f2 is a focal length of the second lens unit L2. νdgn1 is an Abbe number based on the d-line of the negative lens Gn1 that is closest to an object among at least one negative lens included in the first lens unit L1 (referred to as the most object-side negative lens hereinafter). SG is a minimum value of the specific gravity of all lenses included in the second lens unit L2. The specific gravity of a lens here is a ratio of the mass of the lens to that of water of the same volume.

Inequality (1) defines a proper relationship between the focal length f2 of the second lens unit L2, which is the focus unit, and the focal length f of the optical system L0. In a case where lenses with high refractive power made of a resin material are used for the optical system to reduce weight, the aberration fluctuation due to temperature change increases. Inequality (1) illustrates a condition for giving the focus unit proper refractive power while suppressing the aberration fluctuation due to temperature change. In a case where the focal length of the focus unit decreases, that is, in a case where the refractive power of the focus unit increases, so that f2/f becomes higher than the upper limit value of inequality (1), the aberration fluctuation due to temperature change increases. In a case where the focal length of the focus unit increases, that is, in a case where the refractive power of the focus unit is reduced, so that f2/f becomes lower than the lower limit of inequality (1), a moving amount of the focus unit during focusing and finally the size of the optical system L0 increase.

The lower limit of inequality (1) may be set to −8.40, −8.30, −8.20, or −8.10. The upper limit of inequality (1) may be set to −1.20, −1.25, or −1.29.

Inequality (2) defines a proper range of the Abbe number of the negative lens Gn1 closest to the object. The second lens unit L2 uses a material that has negative refractive power and a large partial dispersion ratio θgF for the g-line (wavelength 435.8 nm) and F-line (wavelength 486.1 nm), and thus the impact on lateral chromatic aberration increases. Thus, it is necessary to suppress the lateral chromatic aberration by using a material having a large partial dispersion ratio θgF for the g-line and F-line for the most object-side negative lens Gn1. In this case, the proper range of the material for the most object-side negative lens Gn1 is the range of inequality (2). In a case where νdgn1 becomes higher than the upper limit of inequality (2), it is beneficial to suppressing longitudinal chromatic aberration, but it is difficult to suppress lateral chromatic aberration. In a case where νdgn1 becomes lower than the lower limit of inequality (2), it is beneficial to suppressing longitudinal chromatic aberration, but it is difficult to suppress longitudinal chromatic aberration.

The lower limit of inequality (2) may be set to 12.00, 14.00, 16.00, or 17.00. The upper limit of inequality (2) may be set to 30.70, 30.40, or 30.10.

Inequality (3) defines a proper range for the minimum value of the specific gravity of each of all the lenses in the second lens unit L2. In a case where SG becomes higher than the upper limit of inequality (3), all the lenses in the second lens unit L2 become glass lenses, and the weight of the focus unit increases. In a case where SG becomes lower than the lower limit of inequality (3), it becomes difficult to create a lens with refractive power for focusing.

The lower limit of inequality (3) may be set to 0.85, 0.90, 0.95, or 1.00. The upper limit of inequality (3) may be set to 2.00, 1.70, 1.50, or 1.30.

By satisfying the above configuration and inequalities (1) to (3), the optical system L0 according to each example can reduce the weight and moving amount of the focus unit while achieving high optical performance.

The optical system L0 according to each example may satisfy at least one of the following inequalities (4) to (13):

$$2. \leq TL / f \leq 7 \text{.00} \qquad ( 4 )$$

$$- 2. \leq fgn 1 / f \leq - 0 \text{.50} \qquad ( 5 )$$

$$15. 00 \leq vdgp 1 \leq 40. \qquad ( 6 )$$

$$1. 80 \leq Ndgn 1 \leq 2.15 \qquad ( 7 )$$

$$- 5. \leq ( Rn 2 + Rn 1 ) / ( Rn 2 - Rn 1 ) \leq - 1. \qquad ( 8 )$$

$$0.7 \leq f 1 / f \leq 1.2 \qquad ( 9 )$$

$$0.2 \leq DF / f \leq 1.5 \qquad ( 10 )$$

$$0.14 \leq SK / TL \leq 0 \text{.30} \qquad ( 11 )$$

$$0.35 \leq Db 1 / TL \leq 0 \text{.70} \qquad ( 12 )$$

$$0. < Db 2 / TL \leq 0.10 \qquad ( 13 )$$

In the above inequalities, TL is a distance on the optical axis from a lens surface closest to the object of the optical system L0 to the image plane IP, and is an overall optical length. fgn1 is a focal length of the most object-side negative lens Gn1. νdgp1 is an Abbe number based on the d-line of a positive lens Gp1 closest to the object (referred to as the most object-side positive lens hereinafter) among at least one positive lens included in the first lens unit L1. Ndgn1 is a refractive index of the most object-side negative lens Gn1 for the d-line. Rn1 is a radius of curvature of an object-side lens surface of the most object-side negative lens Gn1, and Rn2 is a radius of curvature of an image-side lens surface of the most object-side negative lens Gn1. f1 is a focal length of the first lens unit L1. DF is a distance on the optical axis from a lens surface closest to the image plane of the second lens unit L2 to an object-side lens surface of a lens adjacent to the second lens unit L2 on the image side or the image plane IP in the in-focus state at infinity. SK is an air-equivalent distance from a lens surface closest to the image plane of the optical system L0 to the image plane IP, and is the back focus. Db1 is the sum of the thicknesses on the optical axis of all lenses included in the first lens unit L1. Db2 is the sum of the thicknesses on the optical axis of all lenses included in the second lens unit L2.

Inequality (4) defines a proper relationship between the overall optical length TL of the optical system L0 and the focal length f of the optical system L0. In a case where TL/f becomes higher than the upper limit of inequality (4), the overall optical length and finally the size of the optical system L0 increase. In a case where TL/f becomes lower than the lower limit of inequality (4), the air gap to suppress a variety of aberrations such as spherical aberration and chromatic aberration cannot be secured, and the increased number of lenses causes the weight to increase.

The lower limit of inequality (4) may be set to 2.10, 2.20, or 2.30. The upper limit of inequality (4) may be set to 6.80, 6.60, or 6.50.

Inequality (5) defines a proper relationship between the focal length fgn1 of the most object-side negative lens Gn1 and the focal length f of the optical system L0. In a case where fgn1/f becomes higher than the upper limit of inequality (5), the negative refractive power of the most object-side negative lens Gn1 increases and distortion increases. In a case where fgn1/f becomes lower than the lower limit of inequality (5), the negative refractive power of the most object-side negative lens Gn1 is reduced and astigmatism increases.

The lower limit of inequality (5) may be set to −1.96, −1.93, or −1.91. The upper limit of inequality (5) may be set to −0.55, −0.58, or −0.60.

Inequality (6) defines a proper range for the Abbe number νdgn1 of the most object-side positive lens Gp1. In a case where νdgn1 becomes higher than the upper limit of inequality (6), it becomes difficult to suppress longitudinal chromatic aberration. In a case where νdgn1 becomes lower than the lower limit of inequality (6), it becomes difficult to suppress lateral chromatic aberration.

The lower limit of inequality (6) may be set to 17.25, 20.00, or 22.00. The upper limit of inequality (6) may be set to 38.00, 37.00, or 36.00.

Inequality (7) defines a proper range for the refractive index Ndgn1 of the negative lens Gn1 closest to the object. In a case where Ndgn1 becomes higher than the upper limit of inequality (7), distortion increases, the partial dispersion ratio θgF for the g-line and F-line increases, and it becomes difficult to suppress longitudinal chromatic aberration. In a case where Ndgn1 becomes lower than the lower limit of inequality (7), it is difficult to suppress lateral chromatic aberration and curvature of field.

The lower limit of inequality (7) may be set to 1.82, 1.83, or 1.84. The upper limit of inequality (7) may be set to 2.10, 2.05, or 2.00.

Inequality (8) defines a proper range for the shape factor (Rn2+Rn1)/(Rn2−Rn1) of the most object-side negative lens Gn1. In a case where the shape factor becomes higher than the upper limit of inequality (8), the radius of curvature of the object-side lens surface becomes too small for the radius of curvature of the image-side lens surface of the most object-side negative lens Gn1, and the curvature of field increases. In a case where the shape factor becomes lower than the lower limit of inequality (8), this is beneficial to suppressing the curvature of field, but the lens diameter of the most object-side negative lens Gn1 and finally the size of the optical system L0 increase.

The lower limit of inequality (8) may be set to −4.75, −4.60, or −4.50. The upper limit of inequality (8) may be set to −1.05, −1.08, or −1.10.

Inequality (9) defines a proper relationship between the focal length f1 of the first lens unit L1 and the focal length f of the optical system L0. In a case where f1/f becomes higher than the upper limit of inequality (9), the refractive power of the first lens unit L1 is reduced, and the overall optical length increases. In a case where f1/f becomes lower than the lower limit of inequality (9), it is beneficial to the size reduction of the focus unit, but spherical aberration and longitudinal chromatic aberration increase.

The lower limit of inequality (9) may be set to 0.71, 0.72, or 0.73. The upper limit of inequality (9) may be set to 1.17, 1.14, or 1.12.

Inequality (10) defines a proper relationship between the distance DF relating to the second lens unit L2 in the in-focus state at infinity and the focal length f of the optical system L0. In a case where DF/f becomes higher than the upper limit of inequality (10), the overall optical length and finally the size of the optical system L0 increase. In a case where DF/f becomes lower than the lower limit of inequality (10), a moving amount of the second lens unit L2 for focusing cannot be secured.

The lower limit of inequality (10) may be set to 0.23, 0.26, 0.30, or 0.32. The upper limit of inequality (10) may be set to 1.40, 1.30, or 1.20.

Inequality (11) defines a proper relationship between the back focus SK and the overall optical length TL. In a case where SK/TL becomes higher than the upper limit of inequality (11), a distance between the lenses in the optical system L0 is reduced, and it becomes difficult to suppress spherical aberration and lateral chromatic aberration. In a case where SK/TL becomes lower than the lower limit of inequality (11), the back focus SK is reduced and spherical aberration and coma increase.

The lower limit of inequality (11) may be set to 0.15 or 0.16. The upper limit of inequality (11) may be set to 0.29, 0.28, or 0.27.

Inequality (12) defines a proper relationship between the sum of the lens thicknesses Db1 of the first lens unit L1 and the overall optical length TL. In a case where Db1/TL becomes higher than the upper limit of inequality (12), the thickness of the first lens unit L1 increases and the weight reduction cannot be achieved. In a case where Db1/TL becomes lower than the lower limit of inequality (12), it becomes difficult to suppress a variety of aberrations.

The lower limit of inequality (12) may be set to 0.37, 0.39, or 0.40. The upper limit of inequality (12) may be set to 0.69 or 0.68.

Inequality (13) defines a proper relationship between the sum of the lens thicknesses Db2 of the second lens unit L2 and the overall optical length TL. In a case where Db2/TL becomes higher than the upper limit of inequality (13), the thickness of the second lens unit L2 and the size of the focus unit increase, and it becomes difficult to reduce the size of the optical system L0. In a case where Db2/TL becomes lower than the lower limit of inequality (13), the thickness of the second lens unit L2 is reduced, but it becomes difficult to mold at least one of the lenses in the second lens unit L2.

The lower limit of inequality (13) may be set to 0.005, 0.007, or 0.009. The upper limit of inequality (13) may be set to 0.09, 0.08, or 0.07.

The optical system L0 according to each example may satisfy at least one of the following configurations.

The lens closest to the image plane of the optical system L0 may have negative refractive power. Thereby, the diameter of the lens closest to the image plane can be reduced.

The first lens unit L1 may include eight lenses or fewer. Thereby, the size and weight of the optical system L0 can be easily reduced.

The second lens unit L2 may include two lenses or fewer. Thereby, the weight of the focus unit can be easily reduced.

The optical system L0 may include ten lenses or fewer. Thereby, the size and weight of the optical system L0 can be easily reduced. In a case where two lenses are cemented together to form a single cemented lens, the number of lenses is counted as two.

Next follows a detailed description of the optical systems L0 according to Examples 1 to 8. After the description according to Example 8 is provided, numerical examples 1 to 8 corresponding to Examples 1 to 8 will be illustrated.

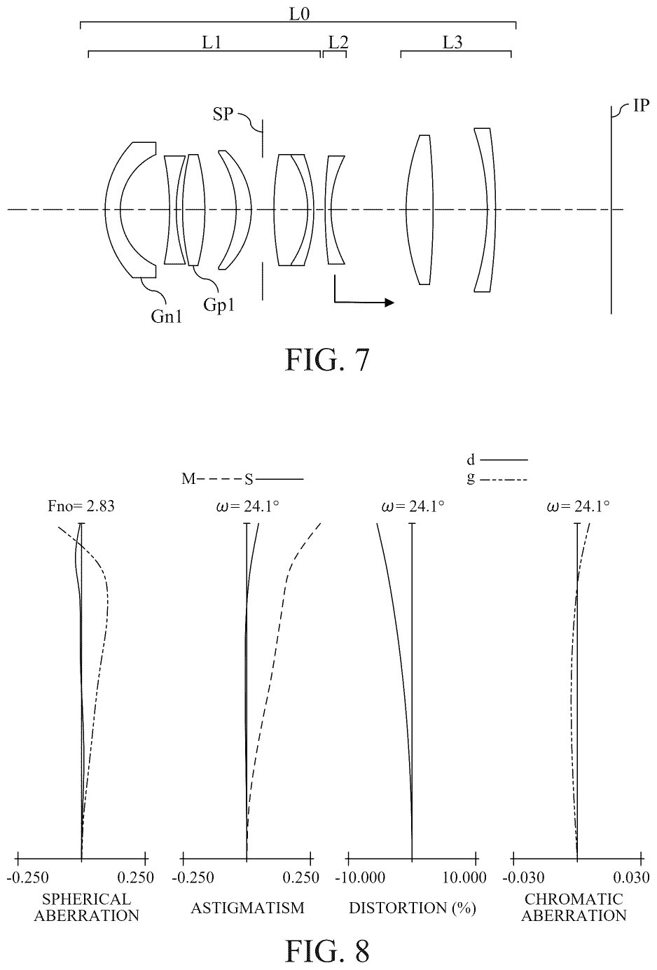

Each of the optical systems L0 according to Example 1 illustrated in FIG. 1 and Example 3 illustrated in FIG. 7 includes a first lens unit L1 disposed closest to the object, a second lens unit L2 adjacent to the first lens unit L1 on the image side, and a third lens unit L3 disposed closest to the image plane. The most object-side negative lens Gn1 is disposed closest to the object in the first lens unit L1, and the most object-side positive lens Gp1 is disposed at the third position counted from the object side. The first lens unit L1 includes six lenses and an aperture stop SP. The focus unit is the second lens unit L2, and includes a single resin lens. The optical system L0 according to this example includes nine lenses.

The optical system L0 according to Example 2 illustrated in FIG. 4 includes the first lens unit L1 disposed on the most object side, and the second lens unit L2 adjacent to the first lens unit L1 on the image side (disposed closest to the image plane). The most object-side negative lens Gn1 is disposed on the most object side of the first lens unit L1, and the most object-side positive lens Gp1 is disposed third from the object side. The first lens unit L1 includes eight lenses and an aperture stop SP. The focus unit is the second lens unit L2, and includes a single resin lens. The optical system L0 according to this example includes nine lenses.

The optical system L0 according to Example 4 illustrated in FIG. 10 includes a first lens unit L1 disposed closest to the object, a second lens unit L2 adjacent to the first lens unit L1 on the image side, and a third lens unit L3 disposed closest to the image plane. The most object-side negative lens Gn1 is disposed closest to the object in the first lens unit L1, and the most object-side positive lens Gp1 is disposed at the third position counted from the object side. The first lens unit L1 includes six lenses and an aperture stop SP. The focus unit is the second lens unit L2, which includes two lenses. Of the two lenses, the lens on the image side is a resin lens. The optical system L0 according to this example includes ten lenses.

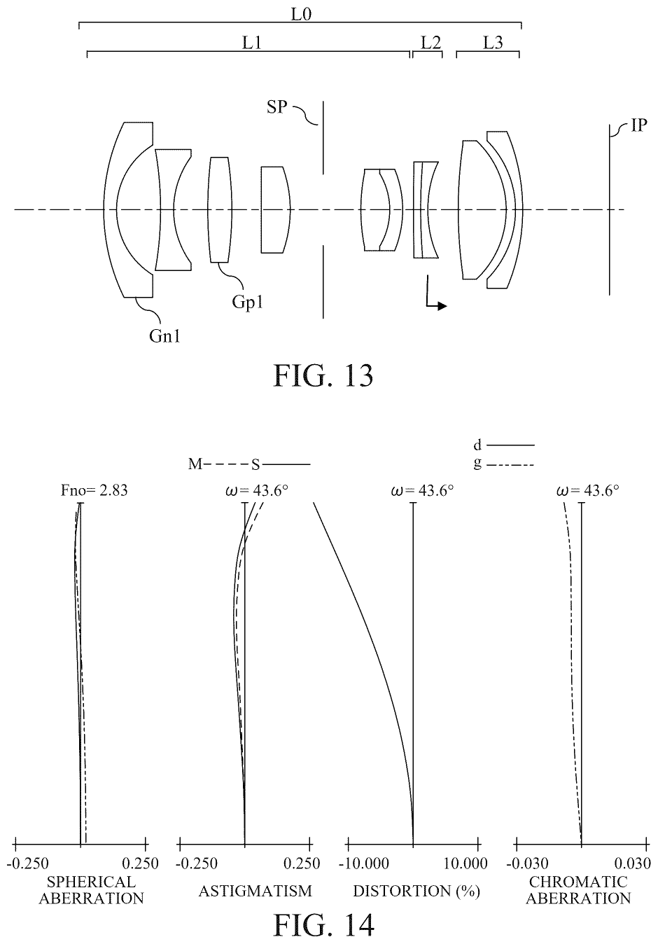

The optical system L0 according to Example 5 illustrated in FIG. 13 includes a first lens unit L1 disposed closest to the object, a second lens unit L2 adjacent to the first lens unit L1 on the image side, and a third lens unit L3 disposed closest to the image plane. The most object-side negative lens Gn1 is disposed closest to the object in the first lens unit L1, and the most object-side positive lens Gp1 is disposed at the third position counted from the object side. The first lens unit L1 includes six lenses and an aperture stop SP. The focus unit is the second lens unit L2, which includes a cemented lens in which two lenses are cemented together. The image-side lens of the cemented lens is a resin lens. The optical system L0 according to this example includes ten lenses.

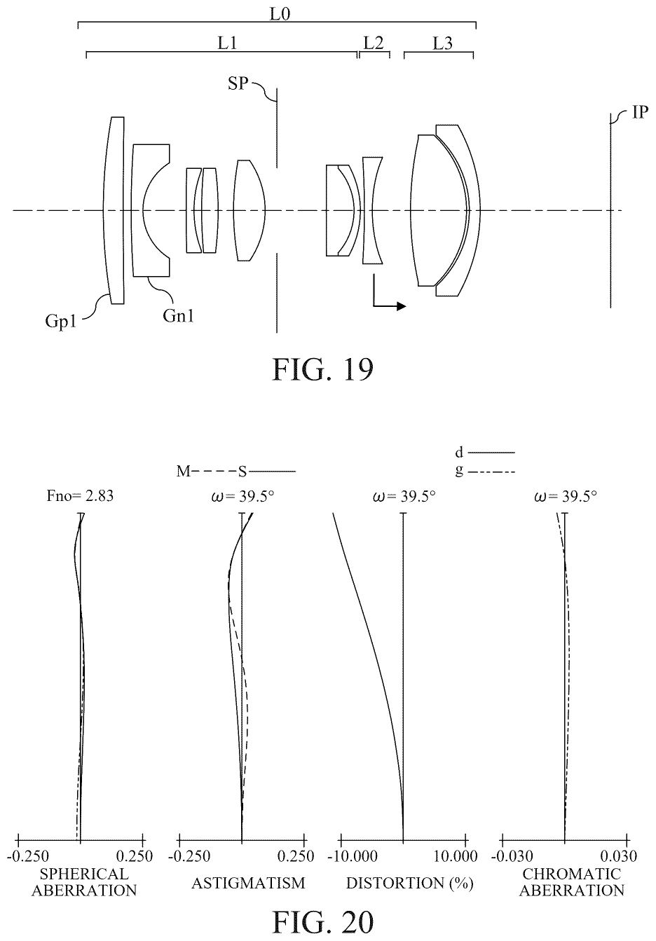

Each of the optical systems L0 according to Example 6 illustrated in FIG. 16, Example 7 illustrated in FIG. 19, and Example 8 illustrated in FIG. 22 includes a first lens unit L1 disposed closest to the object, a second lens unit L2 adjacent to the first lens unit L1 on the image side, and a third lens unit L3 disposed closest to the image plane. The most object-side positive lens Gp1 is disposed closest to the object in the first lens unit L1, and the most object-side positive lens Gn1 is disposed at the second position counted from the object side. The first lens unit L1 includes seven lenses and an aperture stop SP. The focus unit is the second lens unit L2, which includes one resin lens. Each of the optical systems L0 according to these examples includes ten lenses.

Numerical examples 1 to 8 will be illustrated below. In surface data in each numerical example, a surface number m indicates the order of the surface counted from the object side. r (mm) represents a radius of curvature of an m-th surface, d (mm) represents a lens thickness or air gap on the optical axis between m-th and (m+1)-th surface. nd represents a refractive index for the d-line of an optical material between m-th and (m+1)-th surfaces, and νd represents an Abbe number based on the d-line of an optical material between m-th and (m+1)-th surfaces. The Abbe number νd based on the d-line is expressed as follows:

$$vd = ( Nd - 1 ) / ( NF - NC )$$

where Nd, NF, and NC are refractive indices for the d-line (587.56 nm), F-line (486.13 nm), and C-line (656.27 nm).

θgF represents a partial dispersion ratio of an optical material between m-th and (m+1)-th surfaces for the g-line (435.84 nm) and F-line. The partial dispersion ratio θgF is expressed as follows:

$$θ gF = ( Ng - NF ) / ( NF - NC )$$

where Ng is a refractive index for the g-line.

sg represents the specific gravity of an optical material between m-th and (m+1)-th surfaces.

In each numerical example, a surface distance d (mm), focal length (mm), F-number (Fno), and half angle of view (°) calculated by paraxial calculation have all values in the in-focus state at infinity. As described above, the back focus SK is an air-equivalent distance on the optical axis from a lens surface (last surface) closest to the image plane IP in the optical system L0 to the image plane IP. The overall lens length has a value obtained by adding the back focus to a distance from the lens surface (first surface) closest to the object in the optical system L0 to the final surface, and corresponds to the overall optical length described above. The asterisk “*” attached to the surface number means that the surface has an aspheric shape. The aspheric shape is expressed by the following equation:

$$x = ( {h}^{2} / R ) / [ 1 + √ \{ 1 - ( 1 + K ) {( h / R )}^{2} \} ] + A 4 \times {h}^{4} + A 6 \times {h}^{6} + A 8 \times {h}^{8} + A 10 \times {h}^{10}$$

where x is a displacement amount from a surface vertex in the optical axis direction, h is a height from the optical axis in a direction perpendicular to the optical axis, a light traveling direction is positive, R is a paraxial radius of curvature, K is a conic constant, and A4, A6, A8, and A10 are aspheric coefficients.

The “e±M” in the conic constant and aspheric coefficients means×10^{±M}.

Table 1 summarizes values of inequalities (1) to (13) for the optical systems L0 according to numerical examples 1 to 8. Each numerical example satisfies all of inequalities (1) to (13).

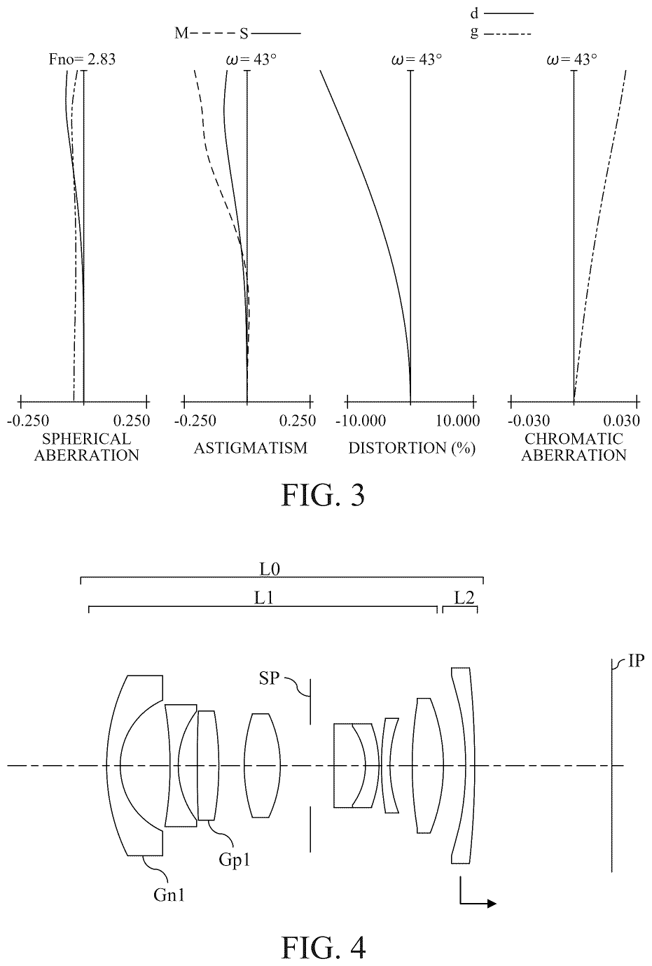

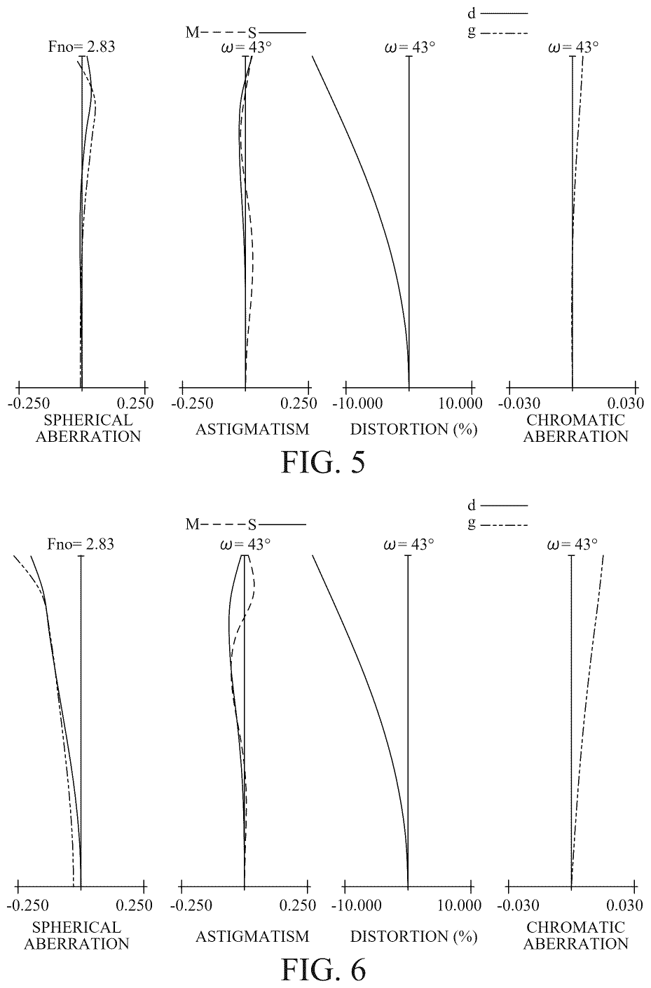

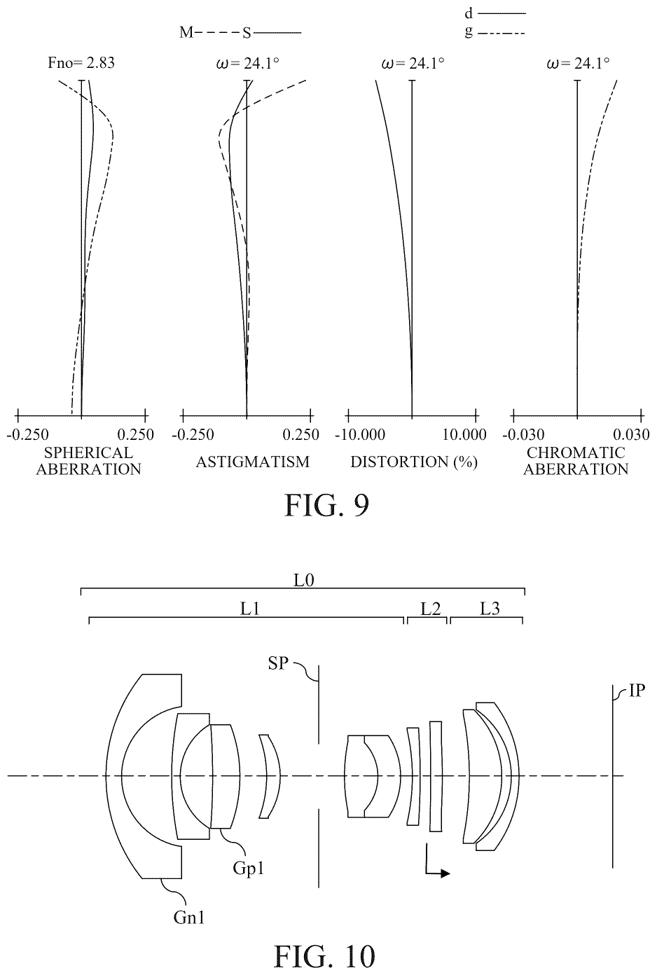

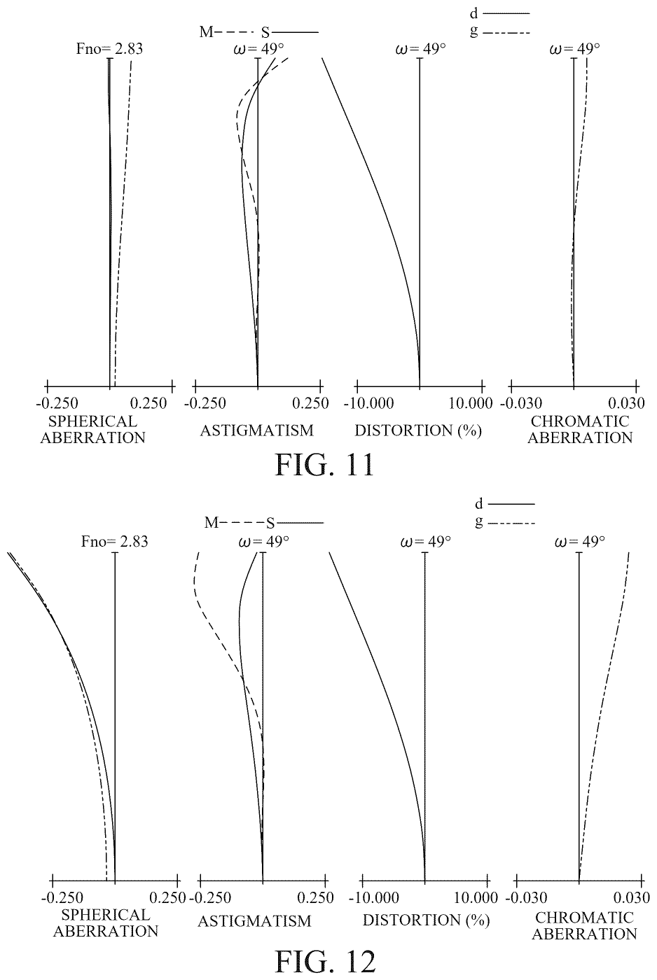

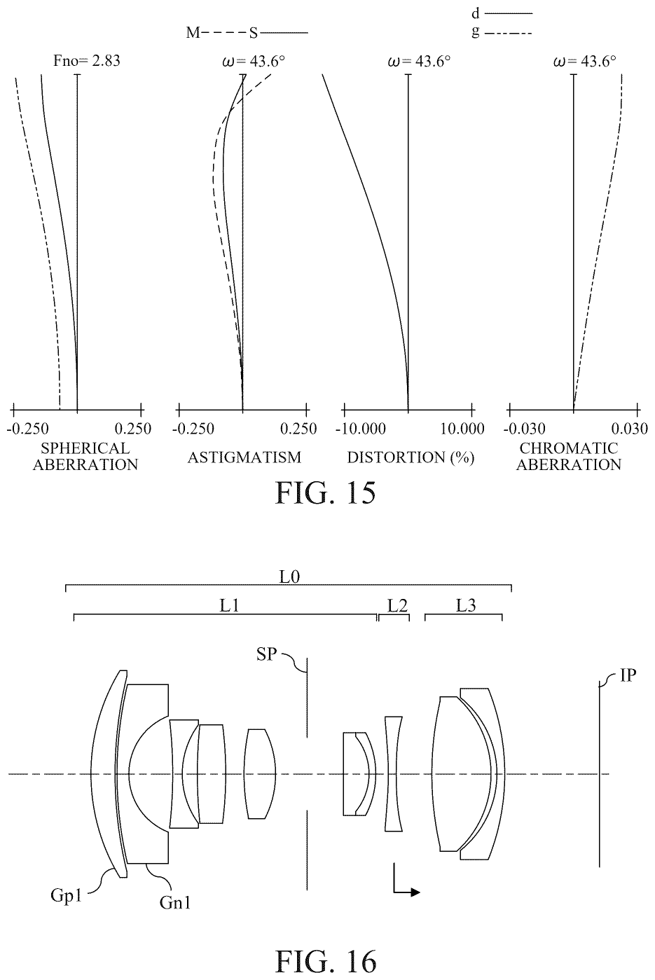

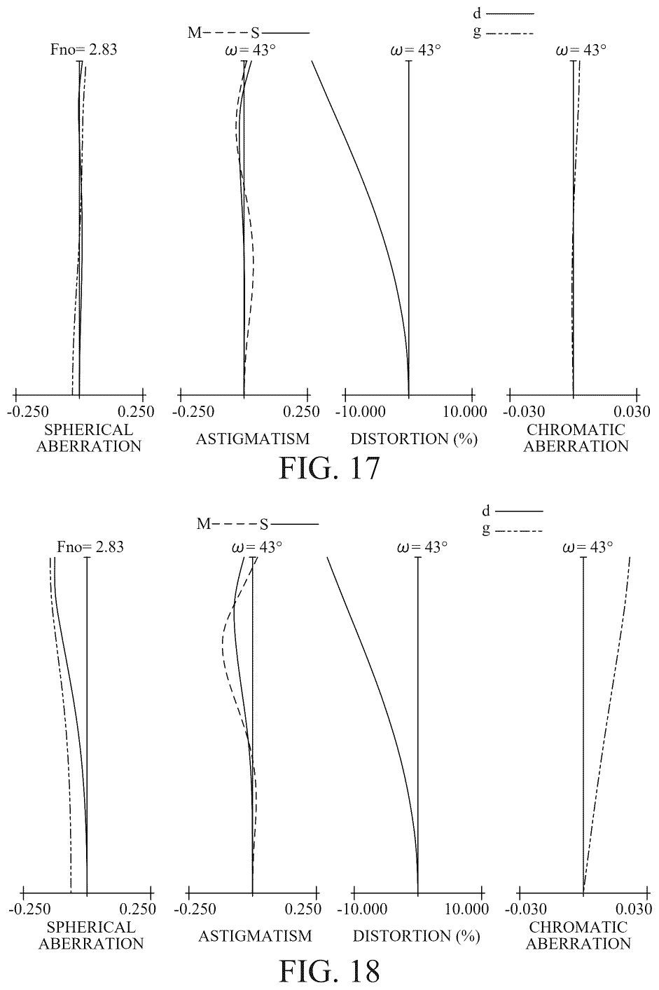

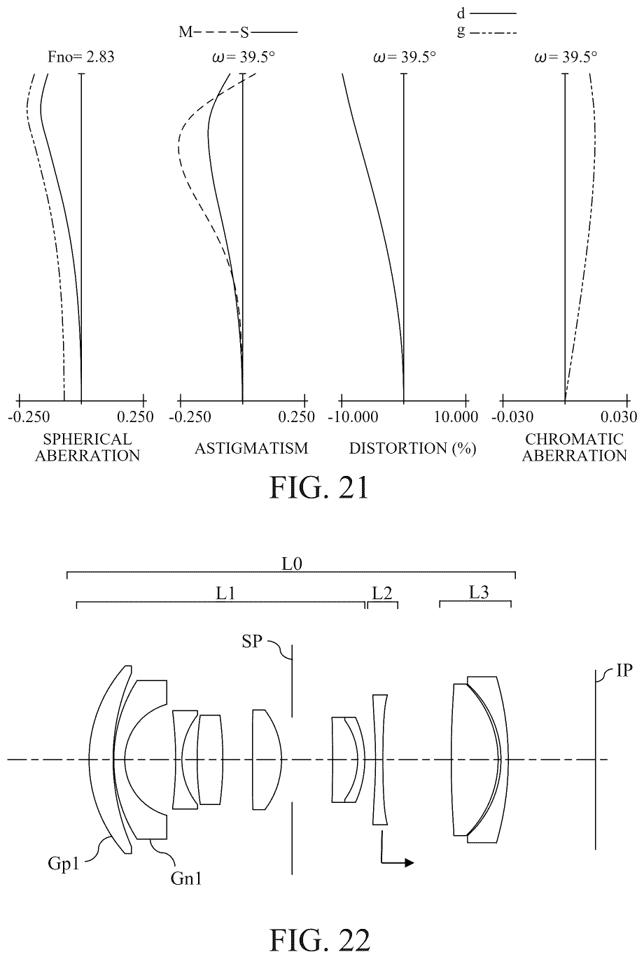

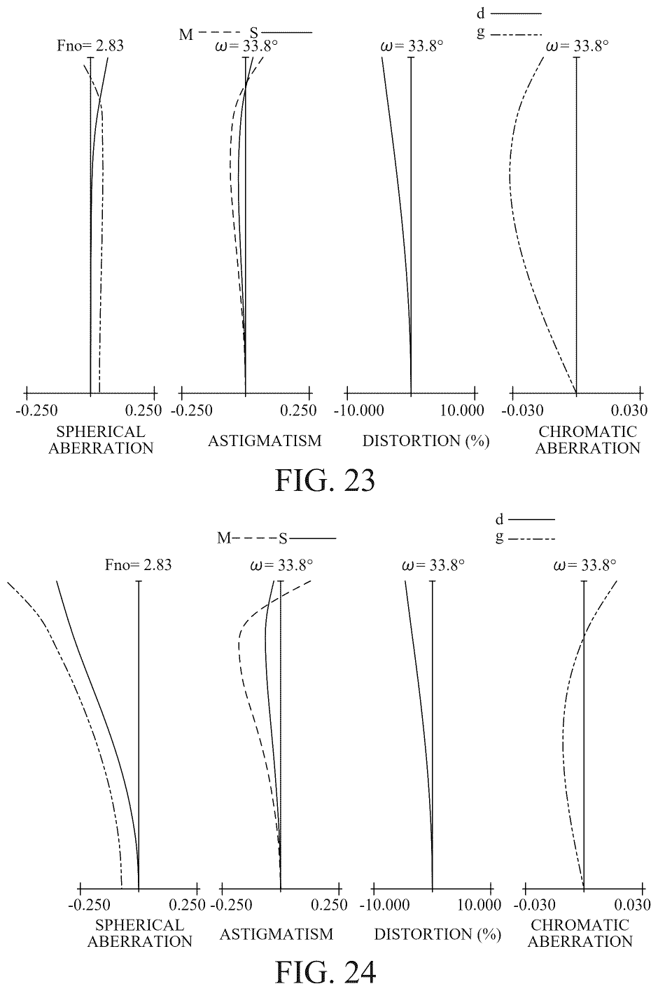

FIGS. 2, 5, 8, 11, 14, 17, 20, and 23 respectively illustrate the longitudinal aberration (spherical aberration, astigmatism, distortion, and chromatic aberration) of the optical systems L0 according to numerical examples 1 to 8 in the in-focus state at infinity. FIGS. 3, 6, 9, 12, 15, 18, 21, and 24 respectively illustrate the longitudinal aberration of the optical systems L0 according to numerical examples 1 to 8 in the in-focus state on an object at the closest distance (in-focus state at the closest distance). In the spherical aberration diagram, Fno represents an F-number. A solid line indicates a spherical aberration amount for the d-line (with a wavelength 587.6 nm), and an alternate long and two short dashes line indicates a spherical aberration amount for the g-line (with a wavelength 435.8 nm). In the astigmatism diagram, a solid line S indicates an astigmatism amount on a sagittal image plane, and a dashed line M indicates an astigmatism amount on a meridional image plane. The distortion diagram illustrates a distortion amount for the d-line. The chromatic aberration diagram illustrates a lateral chromatic aberration amount for the g-line. ω is a half angle of view (°) based on paraxial calculation.

### Numerical Example 1

UNIT: mm
SURFACE DATA

| Surface No. | r | d | nd | νd | θgF | sg |
|---|---|---|---|---|---|---|
| 1 | 17.757 | 1.50 | 1.96300 | 24.1 | 0.621 | 4.20 |
| 2 | 8.341 | 5.46 | | | | |
| 3 | −50.181 | 0.90 | 1.49700 | 81.5 | 0.538 | 3.62 |
| 4 | 10.693 | 2.15 | | | | |
| 5 | 110.017 | 3.65 | 2.00069 | 25.5 | 0.614 | 4.73 |
| 6 | −38.046 | 4.54 | | | | |
| 7 | 57.573 | 4.14 | 1.51633 | 64.1 | 0.535 | 2.52 |
| 8 | −12.938 | 4.08 | | | | |
| 9 (SP) | ∞ | 4.30 | | | | |
| 10 | 3807.287 | 3.32 | 1.49700 | 81.5 | 0.538 | 3.62 |
| 11 | −8.841 | 0.80 | 1.96300 | 24.1 | 0.621 | 4.20 |
| 12 | −13.811 | (Variable) | | | | |
| 13* | −100.000 | 1.00 | 1.53110 | 55.9 | 0.568 | 1.01 |
| 14* | 36.390 | (Variable) | | | | |
| 15 | 34.818 | 5.74 | 1.59522 | 67.7 | 0.544 | 4.17 |
| 16 | −14.251 | 2.10 | | | | |
| 17 | −12.290 | 1.00 | 1.77047 | 29.7 | 0.595 | 3.34 |
| 18 | −27.581 | 12.00 | | | | |
| Image Plane | ∞ | | | | | |

ASPHERIC DATA
13th Surface
K = 0.00000e+00 A 4 = 4.08532e−05 A 6 = 1.71506e−06
A 8 = −8.77665e−08 A10 = 6.80396e−10
14th Surface
K = 0.00000e+00 A 4 = 9.15610e−05 A 6 = −7.41161e−08
A 8 = −2.40331e−08 A10 = 1.01764e−10
VARIOUS DATA

| | |
|---|---|
| Focal Length | 12.38 |
| Fno | 2.83 |
| Half Angle of View (°) | 42.99 |
| Image Height | 11.54 |
| Overall Lens Length | 63.50 |
| SK | 12.00 |

| | Infinity | Closest Distance |
|---|---|---|
| d12 | 1.50 | 3.39 |
| d14 | 5.32 | 3.43 |

LENS UNIT DATA

| Lens Unit | Starting Surface | Focal Length |
|---|---|---|
| 1 | 1 | 13.71 |
| 2 | 13 | −50.11 |
| 3 | 15 | 36.09 |

### Numerical Example 2

UNIT: mm
SURFACE DATA

| Surface No. | r | d | nd | νd | θgF | sg |
|---|---|---|---|---|---|---|
| 1 | 22.255 | 1.50 | 1.85025 | 30.1 | 0.598 | 4.00 |
| 2 | 7.861 | 5.53 | | | | |
| 3 | −39.165 | 0.90 | 1.49700 | 81.5 | 0.538 | 3.62 |
| 4 | 9.825 | 2.10 | | | | |
| 5 | 139.116 | 2.40 | 2.00069 | 25.5 | 0.614 | 4.73 |
| 6 | −34.774 | 2.80 | | | | |
| 7 | 18.183 | 4.00 | 1.51633 | 64.1 | 0.535 | 2.52 |
| 8 | −13.238 | 3.32 | | | | |
| 9 (SP) ∞ | 2.62 | | | | | |
| 10 | 11449.611 | 3.48 | 1.49700 | 81.5 | 0.538 | 3.62 |
| 11 | −7.196 | 1.50 | 2.00069 | 25.5 | 0.614 | 4.73 |
| 12 | −12.769 | 0.27 | | | | |
| 13 | 29.778 | 0.95 | 1.91082 | 35.3 | 0.583 | 4.85 |
| 14 | 14.529 | 2.46 | | | | |
| 15 | 42.415 | 3.46 | 1.59522 | 67.7 | 0.544 | 4.17 |
| 16 | −19.306 | (Variable) | | | | |
| 17* | −34.567 | 1.00 | 1.53110 | 55.9 | 0.568 | 1.01 |
| 18 | −100.000 | (Variable) | | | | |
| Image Plane | ∞ | | | | | |

ASPHERIC DATA
17th Surface
K = 0.00000e+00 A 4 = −3.55752e−05 A 6 = 6.02827e−07
A 8 = −1.18983e−08 A10 = 8.48195e−11
VARIOUS DATA

| | |
|---|---|
| Focal Length | 12.36 |
| Fno | 2.83 |
| Half Angle of View (°) | 43.03 |
| Image Height | 11.54 |
| Overall Lens Length | 55.92 |
| SK | 15.18 |

| | Infinity | Closest Distance |
|---|---|---|
| d16 | 2.46 | 5.63 |
| d18 | 15.18 | 12.00 |

LENS UNIT DATA

| Lens Unit | Starting Surface | Focal Length |
|---|---|---|
| 1 | 1 | 10.64 |
| 2 | 17 | −100.00 |

### Numerical Example 3

UNIT: mm
SURFACE DATA

| Surface No. | r | d | nd | νd | θgF | sg |
|---|---|---|---|---|---|---|
| 1 | 12.633 | 2.00 | 1.92119 | 24.0 | 0.620 | 3.84 |
| 2 | 8.011 | 6.54 | | | | |
| 3 | −35.859 | 0.87 | 1.49700 | 81.5 | 0.538 | 3.62 |
| 4 | 21.118 | 0.84 | | | | |
| 5 | 31.182 | 2.97 | 1.91082 | 35.3 | 0.583 | 4.85 |
| 6 | −29.101 | 4.14 | | | | |
| 7 | −13.300 | 2.00 | 1.49700 | 81.5 | 0.538 | 3.62 |
| 8 | −10.593 | 1.49 | | | | |
| 9 (SP) | ∞ | 1.50 | | | | |
| 10 | 40.090 | 4.49 | 1.49700 | 81.5 | 0.538 | 3.62 |
| 11 | −12.533 | 0.79 | 1.84666 | 23.8 | 0.621 | 3.54 |
| 12 | −20.783 | (Variable) | | | | |
| 13* | 63.007 | 0.79 | 1.53110 | 55.9 | 0.568 | 1.01 |
| 14* | 14.792 | (Variable) | | | | |
| 15 | 27.364 | 3.58 | 1.59522 | 67.7 | 0.544 | 4.17 |
| 16 | −100.000 | 7.17 | | | | |
| 17 | −32.967 | 1.10 | 1.73037 | 32.2 | 0.590 | 3.18 |
| 18 | −77.077 | 15.32 | | | | |
| Image Plane | ∞ | | | | | |

ASPHERIC DATA
13th Surface
K = 0.00000e+00 A 4 = 1.13281e−04 A 6 = −5.88547e−06
A 8 = 1.48510e−07 A10 = −1.37510e−09
14th Surface
K = 0.00000e+00 A 4 = 1.12815e−04 A 6 = −7.18003e−06
A 8 = 1.81349e−07 A10 = −1.68669e−09
VARIOUS DATA

| | |
|---|---|
| Focal Length | 28.17 |
| Fno | 2.83 |
| Half Angle of View (°) | 24.14 |
| Image Height | 12.63 |
| Overall Lens Length | 67.03 |
| SK | 15.32 |

| | Infinity | Closest Distance |
|---|---|---|
| d12 | 1.50 | 2.45 |
| d14 | 9.94 | 8.99 |

LENS UNIT DATA

| Lens Unit | Starting Surface | Focal Length |
|---|---|---|
| 1 | 1 | 21.07 |
| 2 | 13 | −36.60 |
| 3 | 15 | 56.24 |

### Numerical Example 4

UNIT: mm
SURFACE DATA

| Surface No. | r | d | nd | νd | θgF | sg |
|---|---|---|---|---|---|---|
| 1 | 20.486 | 2.00 | 1.92119 | 24.0 | 0.620 | 3.84 |
| 2 | 8.996 | 6.43 | | | | |
| 3 | 41.199 | 1.10 | 1.49700 | 81.5 | 0.538 | 3.62 |
| 4 | 7.684 | 4.16 | | | | |
| 5 | −88.281 | 3.50 | 1.85896 | 22.7 | 0.628 | 3.71 |
| 6 | −18.346 | 3.43 | | | | |
| 7 | −14.819 | 1.74 | 1.49700 | 81.5 | 0.538 | 3.62 |
| 8 | −9.242 | 4.94 | | | | |
| 9 (SP) | ∞ | 3.31 | | | | |
| 10 | 22.426 | 4.29 | 1.49700 | 81.5 | 0.538 | 3.62 |
| 11 | −6.240 | 2.92 | 2.00100 | 29.1 | 0.600 | 5.12 |
| 12 | −9.312 | (Variable) | | | | |
| 13 | −26.184 | 1.00 | 2.00069 | 25.5 | 0.614 | 4.73 |
| 14 | −91.909 | 1.35 | | | | |
| 15 | −241.401 | 1.50 | 1.53110 | 55.9 | 0.568 | 1.01 |
| 16* | −60.911 | (Variable) | | | | |
| 17 | −40.717 | 4.16 | 1.59522 | 67.7 | 0.544 | 4.17 |
| 18 | −11.874 | 1.22 | | | | |
| 19 | −10.288 | 1.00 | 1.90110 | 27.1 | 0.607 | 3.83 |
| 20 | −15.449 | 12.00 | | | | |
| Image Plane | ∞ | | | | | |

ASPHERIC DATA
16th Surface
K = 0.00000e+00 A 4 = 1.36289e−04 A 6 = −1.53262e−07
A 8 −8.38089e−10 A10 = −3.38821e−12
VARIOUS DATA

| | |
|---|---|
| Focal Length | 10.02 |
| Fno | 2.83 |
| Half Angle of View (°) | 48.98 |
| Image Height | 11.52 |
| Overall Lens Length | 65.00 |
| SK | 12.00 |

| | Infinity | Closest Distance |
|---|---|---|
| d12 | 1.50 | 2.19 |
| d16 | 3.46 | 2.77 |

LENS UNIT DATA

| Lens Unit | Starting Surface | Focal Length |
|---|---|---|
| 1 | 1 | 7.43 |
| 2 | 13 | −50.03 |
| 3 | 17 | 101.02 |

### Numerical Example 5

UNIT: mm
SURFACE DATA

| Surface No. | r | d | nd | νd | θgF | sg |
|---|---|---|---|---|---|---|
| 1 | 26.940 | 1.78 | 1.95906 | 17.5 | 0.660 | 3.59 |
| 2 | 10.423 | 6.10 | | | | |
| 3 | −47.125 | 1.80 | 1.49700 | 81.5 | 0.538 | 3.62 |
| 4 | 12.245 | 4.73 | | | | |
| 5 | 61.049 | 3.34 | 2.00069 | 25.5 | 0.614 | 4.73 |
| 6 | −47.248 | 4.08 | | | | |
| 7 | 2307.926 | 4.00 | 1.56732 | 42.8 | 0.573 | 2.57 |
| 8 | −17.117 | 4.56 | | | | |
| 9 (SP) | ∞ | 5.21 | | | | |
| 10 | 25.369 | 4.01 | 1.49700 | 81.5 | 0.538 | 3.62 |
| 11 | −9.668 | 1.79 | 2.00069 | 25.5 | 0.614 | 4.73 |
| 12 | −14.664 | (Variable) | | | | |
| 13 | 304.436 | 0.99 | 1.92286 | 18.9 | 0.650 | 3.58 |
| 14 | 80.176 | 0.99 | 1.63550 | 23.9 | 0.636 | 1.24 |
| 15* | 17.278 | (Variable) | | | | |
| 16 | 62.198 | 6.64 | 1.59522 | 67.7 | 0.544 | 4.17 |
| 17 | −13.016 | 1.28 | | | | |
| 18 | −13.439 | 1.00 | 1.77047 | 29.7 | 0.595 | 3.34 |
| 19 | −27.491 | 12.00 | | | | |
| Image Plane | ∞ | | | | | |

ASPHERIC DATA
15th Surface
K = 0.00000e+00 A 4 = 8.16502e−05 A 6 = 4.61430e−09
A 8 = −3.40059e−11A10 = −1.71027e−11
VARIOUS DATA

| | |
|---|---|
| Focal Length | 12.09 |
| Fno | 2.83 |
| Half Angle of View (°) | 43.65 |
| Image Height | 11.54 |
| Overall Lens Length | 70.00 |
| SK | 12.00 |

| | Infinity | Closest Distance |
|---|---|---|
| d12 | 1.49 | 2.28 |
| d15 | 4.20 | 3.41 |

LENS UNIT DATA

| Lens Unit | Starting Surface | Focal Length |
|---|---|---|
| 1 | 1 | 9.38 |
| 2 | 13 | −26.82 |
| 3 | 16 | 36.61 |

### Numerical Example 6

UNIT: mm
SURFACE DATA

| Surface No. | r | d | nd | νd | θgF | sg |
|---|---|---|---|---|---|---|
| 1 | 24.873 | 3.05 | 1.92119 | 24.0 | 0.620 | 3.84 |
| 2 | 50.889 | 0.25 | | | | |
| 3 | 48.416 | 1.50 | 1.96300 | 24.1 | 0.621 | 4.20 |
| 4 | 7.828 | 5.56 | | | | |
| 5 | −58.456 | 1.20 | 1.49700 | 81.5 | 0.538 | 3.62 |
| 6 | 10.399 | 1.91 | | | | |
| 7 | 59.138 | 3.60 | 1.96300 | 24.1 | 0.621 | 4.20 |
| 8 | −47.434 | 2.31 | | | | |
| 9 | 26.837 | 4.00 | 1.48749 | 70.2 | 0.530 | 2.46 |
| 10 | −12.203 | 3.99 | | | | |
| 11 (SP) | ∞ | 4.60 | | | | |
| 12 | 6008.192 | 3.25 | 1.49700 | 81.5 | 0.538 | 3.62 |
| 13 | −7.395 | 0.85 | 2.00069 | 25.5 | 0.614 | 4.73 |
| 14 | −11.072 | (Variable) | | | | |
| 15* | −43.192 | 1.00 | 1.53110 | 55.9 | 0.568 | 1.01 |
| 16* | 51.581 | (Variable) | | | | |
| 17 | 40.612 | 7.50 | 1.59522 | 67.7 | 0.544 | 4.17 |
| 18 | −13.022 | 0.74 | | | | |
| 19 | −12.286 | 1.00 | 1.77047 | 29.7 | 0.595 | 3.34 |
| 20 | −28.539 | 12.00 | | | | |
| Image Plane | ∞ | | | | | |

ASPHERIC DATA
15th Surface
K = 0.00000e+00 A 4 = 2.73879e−05 A 6 = 1.68646e−06
A 8 = −3.42923e−08 A10 = 3.47134e−10
16th Surface
K = 0.00000e+00 A 4 = 9.03920e−05 A 6 = −2.94746e−08
A 8 = 2.27189e−08 A10 = −3.78789e−10
VARIOUS DATA

| | |
|---|---|
| Focal Length | 12.36 |
| Fno | 2.83 |
| Half Angle of View (°) | 43.03 |
| Image Height | 11.54 |
| Overall Lens Length | 64.43 |
| SK | 12.00 |

| | Infinity | Closest Distance |
|---|---|---|
| d14 | 1.58 | 3.04 |
| d16 | 4.51 | 3.06 |

LENS UNIT DATA

| Lens Unit | Starting Surface | Focal Length |
|---|---|---|
| 1 | 1 | 11.87 |
| 2 | 15 | −44.10 |
| 3 | 17 | 39.28 |

### Numerical Example 7

UNIT: mm
SURFACE DATA

| Surface No. | r | d | nd | νd | θgF | sg |
|---|---|---|---|---|---|---|
| 1 | 66.465 | 2.53 | 1.91082 | 35.3 | 0.583 | 4.85 |
| 2 | 789.424 | 1.00 | | | | |
| 3 | 117.037 | 1.49 | 1.85025 | 30.1 | 0.598 | 4.00 |
| 4 | 7.035 | 5.47 | | | | |
| 5 | 180.595 | 1.00 | 1.49700 | 81.5 | 0.538 | 3.62 |
| 6 | 14.081 | 0.97 | | | | |
| 7 | 56.655 | 2.09 | 1.96300 | 24.1 | 0.621 | 4.20 |
| 8 | −42.392 | 1.95 | | | | |
| 9 | 34.381 | 4.00 | 1.49700 | 81.5 | 0.538 | 3.62 |
| 10 | −11.103 | 1.48 | | | | |
| 11 (SP) | ∞ | 6.27 | | | | |
| 12 | ∞ | 3.51 | 1.49700 | 81.5 | 0.538 | 3.62 |
| 13 | −7.990 | 0.80 | 2.00069 | 25.5 | 0.614 | 4.73 |
| 14 | −11.726 | (Variable) | | | | |
| 15* | −94.948 | 1.00 | 1.53110 | 55.9 | 0.568 | 1.01 |
| 16* | 19.217 | (Variable) | | | | |
| 17 | 41.901 | 7.10 | 1.59522 | 67.7 | 0.544 | 4.17 |
| 18 | −12.965 | 0.35 | | | | |
| 19 | −12.798 | 1.38 | 2.00100 | 29.1 | 0.600 | 5.12 |
| 20 | −21.646 | 16.54 | | | | |
| Image Plane | ∞ | | | | | |

ASPHERIC DATA
15th Surface
K = 0.00000e+00 A 4 = −4.30821e−05 A 6 = 8.08773e−07
A 8 = 5.42521e−08 A10 = −1.01539e−09
16th Surface
K = 0.00000e+00 A 4 = 1.10647e−05 A 6 = −2.96188e−08
A 8 = 6.51392e−08 A10 = −1.01239e−09
VARIOUS DATA

| | |
|---|---|
| Focal Length | 14.63 |
| Fno | 2.83 |
| Half Angle of View (°) | 39.45 |
| Image Height | 12.04 |
| Overall Lens Length | 64.29 |
| SK | 16.54 |

| | Infinity | Closest Distance |
|---|---|---|
| d14 | 0.52 | 1.71 |
| d16 | 4.84 | 3.65 |

LENS UNIT DATA

| Lens Unit | Starting Surface | Focal Length |
|---|---|---|
| 1 | 1 | 12.01 |
| 2 | 15 | −30.00 |
| 3 | 17 | 35.25 |

### Numerical Example 8

UNIT: mm
SURFACE DATA

| Surface No. | r | d | nd | νd | θgF | sg |
|---|---|---|---|---|---|---|
| 1 | 19.278 | 3.36 | 1.96300 | 24.1 | 0.621 | 4.20 |
| 2 | 29.448 | 0.10 | | | | |
| 3 | 20.244 | 1.52 | 1.95906 | 17.5 | 0.660 | 3.59 |
| 4 | 7.984 | 7.12 | | | | |
| 5 | −53.297 | 0.87 | 1.49700 | 81.5 | 0.538 | 3.62 |
| 6 | 9.891 | 2.12 | | | | |
| 7 | 42.667 | 3.61 | 2.00069 | 25.5 | 0.614 | 4.73 |
| 8 | −46.071 | 4.12 | | | | |
| 9 | 408.385 | 4.07 | 1.49700 | 81.5 | 0.538 | 3.62 |
| 10 | −11.422 | 1.48 | | | | |
| 11 (SP) | ∞ | 5.66 | | | | |
| 12 | −209.171 | 3.50 | 1.49700 | 81.5 | 0.538 | 3.62 |
| 13 | −9.273 | 0.99 | 2.00069 | 25.5 | 0.614 | 4.73 |
| 14 | −14.029 | (Variable) | | | | |
| 15* | −76.849 | 1.03 | 1.53110 | 55.9 | 0.568 | 1.01 |
| 16* | 129.756 | (Variable) | | | | |
| 17 | 136.599 | 6.55 | 1.59522 | 67.7 | 0.544 | 4.17 |
| 18 | −14.606 | 0.40 | | | | |
| 19 | −14.144 | 1.02 | 1.77047 | 29.7 | 0.595 | 3.34 |
| 20 | −40.808 | 12.17 | | | | |
| Image Plane | ∞ | | | | | |

ASPHERIC DATA
15th Surface
K = 0.00000e+00 A 4 = −3.28362e−06 A 6 = 3.79608e−07
A 8 = −1.04343e−09 A10 = 1.08678e−11
16th Surface
K = 0.00000e+00 A 4 = 1.76211e−05 A 6 = 1.49914e−07
A 8 = 1.84632e−09 A10 = 1.63421e−11
VARIOUS DATA

| | |
|---|---|
| Focal Length | 18.13 |
| Fno | 2.83 |
| Half Angle of View (°) | 33.83 |
| Image Height | 12.15 |
| Overall Lens Length | 70.71 |
| SK | 12.17 |

| | Infinity | Closest Distance |
|---|---|---|
| d14 | 1.50 | 3.30 |
| d16 | 9.54 | 7.74 |

LENS UNIT DATA

| Lens Unit | Starting Surface | Focal Length |
|---|---|---|
| 1 | 1 | 16.11 |
| 2 | 15 | −90.72 |
| 3 | 17 | 98.62 |

TABLE 1

| | Numerical Example | | | | | | | |
|---|---|---|---|---|---|---|---|---|
| Inequality | 1 | 2 | 3 | 4 | 5 | 6 | 7 | 8 |
| (1) | −4.05 | −8.09 | −1.30 | −4.99 | −2.22 | −3.57 | −2.05 | −5.00 |
| (2) | 24.11 | 30.05 | 23.96 | 23.96 | 17.47 | 24.11 | 30.05 | 17.47 |
| (3) | 1.01 | 1.01 | 1.01 | 1.01 | 1.24 | 1.01 | 1.01 | 1.01 |
| (4) | 5.13 | 4.52 | 2.38 | 6.49 | 5.79 | 5.21 | 4.39 | 3.90 |
| (5) | −1.43 | −1.21 | −1.06 | −1.90 | −1.55 | −0.80 | −0.61 | −0.81 |
| (6) | 25.46 | 25.46 | 35.25 | 22.73 | 25.46 | 23.96 | 35.25 | 24.11 |
| (7) | 1.96 | 1.85 | 1.92 | 1.92 | 1.96 | 1.96 | 1.85 | 1.96 |
| (8) | −2.77 | −2.09 | −4.47 | −2.57 | −2.26 | −1.39 | −1.13 | −2.30 |
| (9) | 1.11 | 0.86 | 0.75 | 0.74 | 0.78 | 0.96 | 0.82 | 0.89 |
| (10) | 0.43 | 1.16 | 0.35 | 0.35 | 0.35 | 0.37 | 0.33 | 0.53 |
| (11) | 0.19 | 0.21 | 0.23 | 0.18 | 0.17 | 0.19 | 0.26 | 0.17 |
| (12) | 0.55 | 0.67 | 0.41 | 0.58 | 0.59 | 0.56 | 0.51 | 0.54 |
| (13) | 0.02 | 0.02 | 0.01 | 0.06 | 0.03 | 0.02 | 0.02 | 0.01 |

### Image Pickup Apparatus

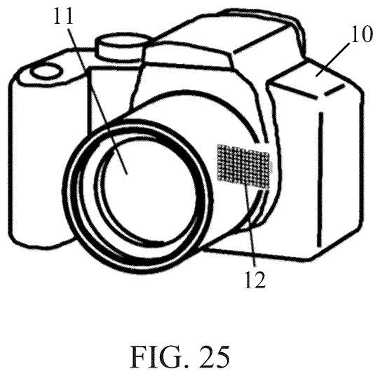

FIG. 25 illustrates a digital still camera (image pickup apparatus) that uses the optical system L0 according to any one of Examples 1 to 8 as an imaging optical system.

Reference numeral 10 denotes a camera body, and reference numeral 11 denotes an imaging optical system that includes the optical system L0 according to any one of Examples 1 to 8.

Reference numeral 12 denotes a solid-state image sensor (photoelectric conversion element) such as a CCD sensor or CMOS sensor that is built into the camera body 10 and captures an optical image formed by the imaging optical system 11 (i.e., captures an object through the imaging optical system 11).

The camera body 10 may be a single-lens reflex camera with a quick-turn mirror, or a mirrorless camera without a quick-turn mirror.

The optical system L0 according to any one of Examples 1 to 8 to an image pickup apparatus such as a digital still camera can provide an image pickup apparatus that is quiet, low-vibration, and high-speed autofocus (AF).

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

Each example according to the disclosure can provide an optical system and an image pickup apparatus, each of which can reduce the weight and moving amount of the lens unit that moves during focusing, thereby achieving higher optical performance.

This application claims the benefit of Japanese Patent Application No. 2024-158008, which was filed on Sep. 12, 2024, and which is hereby incorporated by reference herein in its entirety.

What is claimed is:

1. An optical system comprising, in order from an object side to an image side:
a first lens unit with positive refractive power; and
a second lens unit with negative refractive power,
wherein the optical system is a fixed focal length lens,
wherein each distance between adjacent lens units changes during focusing,
wherein during focusing, the first lens unit does not move and the second lens unit moves, and
wherein the following inequality is satisfied:
$$- 8.50 \leq f 2 / f \leq - 1 \text{.15}$$
$$10. \leq vdgn 1 \leq 31.$$
$$0.8 \leq SG \leq 2.38$$
where f is a focal length of the optical system, f2 is a focal length of the second lens unit, νdgn1 is an Abbe number based on d-line of a negative lens closest to an object among at least one negative lens included in the first lens unit, and SG is a minimum value of specific gravities of all lenses included in the second lens unit.

2. The optical system according to claim 1, wherein the following inequality is satisfied:
$$2. \leq TL / f \leq 7.00$$
where TL is a distance on an optical axis from a lens surface closest to the object of the optical system to an image plane.

3. The optical system according to claim 1, wherein the following inequality is satisfied:
$$- 2.00 \leq fgn 1 / f \leq - 0.50$$
where fgn1 is a focal length of the negative lens closest to the object.

4. The optical system according to claim 1, wherein the following inequality is satisfied:
$$15. \leq vdgp 1 \leq 40.$$
where νdgp1 is an Abbe number based on the d-line of a positive lens closest to the object of at least one positive lens included in the first lens unit.

5. The optical system according to claim 1, wherein the following inequality is satisfied:
$$1. 80 \leq Ndgn 1 \leq 2.15$$
where Ndgn1 is a refractive index for the d-line of the negative lens closest to the object.

6. The optical system according to claim 1, wherein the following inequality is satisfied:
$$- 5. \leq ( Rn 2 + Rn 1 ) / ( Rn 2 - Rn 1 ) \leq - 1.$$
where Rn1 is a radius of curvature of a lens surface on the object side of the negative lens closest to the object, and Rn2 is a radius of curvature of a lens surface on the image side of the negative lens closest to the object.

7. The optical system according to claim 1, wherein the following inequality is satisfied:
$$0.7 \leq f 1 / f \leq 1.2$$
where f1 is a focal length of the first lens unit.

8. The optical system according to claim 1, wherein the following inequality is satisfied:
$$0.2 \leq DF / f \leq 1.5$$
where in an in-focus state on the object at infinity, DF is a distance on an optical axis from a lens surface closest to an image plane of the second lens unit to a lens surface on the object of a lens adjacent to the second lens unit on the image side or the image plane.

9. The optical system according to claim 1, wherein the following inequality is satisfied:
$$0.14 \leq SK / TL \leq 0.30$$
where TL is a distance on an optical axis from a lens surface closest to the object of the optical system to an image plane, and SK is an air-equivalent distance on the optical axis from a lens surface closest to the image plane of the optical system to the image plane.

10. The optical system according to claim 1, wherein the following inequality is satisfied:
$$0.35 \leq Db 1 / TL \leq 0.70$$
where TL is a distance on an optical axis from a lens surface closest to the object of the optical system to an image plane, and Db1 is a sum of thicknesses on the optical axis of all lenses included in the first lens unit.

11. The optical system according to claim 1, wherein the following inequality is satisfied:
$$0. < Db 2 / TL \leq 0.10$$
where TL is a distance on an optical axis from a lens surface closest to the object of the optical system to an image plane, and Db2 is a sum of thicknesses on the optical axis of all lenses included in the second lens unit.

12. The optical system according to claim 1, wherein a lens closest to an image plane in the optical system has negative refractive power.

13. The optical system according to claim 1, wherein the first lens unit includes eight lenses or fewer.

14. The optical system according to claim 1, wherein the second lens unit includes two lenses or fewer.

15. The optical system according to claim 1, wherein the optical system includes ten lenses or fewer.

16. The optical system according to claim 1, wherein the optical system includes the first lens unit and the second lens unit.

17. The optical system according to claim 1, wherein the optical system comprises, in order from the object side to the image side:
the first lens unit;
the second lens unit; and
a third lens unit with positive refractive power that does not move during focusing.

18. An image pickup apparatus comprising:
an optical system; and
an image sensor configured to capture an object through the optical system,
wherein the optical system includes, in order from an object side to an image side:
a first lens unit with positive refractive power; and
a second lens unit with negative refractive power,
wherein the optical system is a fixed focal length lens,
wherein each distance between adjacent lens units changes during focusing,
wherein during focusing, the first lens unit does not move and the second lens unit moves, and
wherein the following inequality is satisfied:
$$- 8.50 \leq f 2 / f \leq - 1 \text{.15}$$
$$10. \leq vdgn 1 \leq 31.$$
$$0.8 \leq SG \leq 2.38$$
where f is a focal length of the optical system, f2 is a focal length of the second lens unit, νdgn1 is an Abbe number based on d-line of a negative lens closest to an object among at least one negative lens included in the first lens unit, and SG is a minimum value of specific gravities of all lenses included in the second lens unit.
